(19) United States
(12) Patent Application Publication
(10) Pub. No.: US 2020/0348926 A1
(43) Pub. Date: Nov. 5, 2020

(54) SYSTEM AND METHOD FOR AUTOMATING ENVIRONMENT MANAGEMENT OF ONE OR MORE SOFTWARE APPLICATIONS

(71) Applicant: Cognizant Technology Solutions India Pvt. Ltd., Chennai, TN (US)

(72) Inventors: Bibhas Rakshit, West Bengal (IN); Debapratim Sarkar, West Bengal (IN); Abhiraj Panja, West Bengal (IN); Mitali Dutta, West Bengal (IN)

(21) Appl. No.: 16/508,370

(22) Filed: Jul. 11, 2019

(30) Foreign Application Priority Data
May 3, 2019 (IN) 201941017794

(51) Int. Cl. G06F 8/70; G06F 9/48; G06F 11/36

(52) U.S. Cl. CPC G06F 8/70; G06N 20/00; G06F 11/3688; G06F 9/4843

(57) ABSTRACT

A system for automating environment management of one or more software applications. The system comprises a scheduler module configured to schedule one or more workflows in at least one of: a release calendar mode and an ad hoc mode. The one or more scheduled workflows are populated in a database associated with the scheduler module. The system further comprises a master controller configured to execute the one or more scheduled workflows by accessing details of the one or more scheduled workflows from an execution queue communicatively coupled to the database associated with the scheduler module. The system furthermore comprises an artificial intelligence based user interface module configured to facilitate the scheduling and execution of the one or more workflows, the user interface module is communicatively coupled to the scheduler module and the master controller.

### FIELD OF THE INVENTION

The present invention relates generally to environment management of software applications. In particular, the present invention relates to a system and method to automate release planning, testing, maintenance, and monitoring of the software applications.

### BACKGROUND OF THE INVENTION

In today's time information technology applications and systems are being created at a rapid rate. However, while developing new applications and systems is required, an adequate release testing of the applications prior to being implemented is even more critical. While there are many tools and solutions available in the market that address issues with one or more aspects of release testing of the applications, aspects such as application support and environment support still need lot of improvement.

For example, there are solutions available in the market that facilitate environment managers to get complete control of test environment management throughout the enterprise with a consolidated end-to-end view of configuration and allocation. However, these solutions fall short of being used in a cross platform environment such as WINDOWS, UNIX and MAINFRAME. Also, these existing solutions are not capable of creating any workflow to help environment management process. Further, while some other existing solutions can be used to create workflows to help release management operational activities they do not focus on release management and also do not facilitate release planning activities.

In light of the above, there is a need for a solution that facilitates release planning, testing, maintenance, and monitoring of the applications by handling application support and environment support activities in an automated manner.

### SUMMARY OF THE INVENTION

In an embodiment of the present invention, a system for automating environment management of one or more software applications is provided. The system comprises a scheduler module configured to schedule one or more workflows in at least one of: a release calendar mode and an ad hoc mode. The one or more scheduled workflows are populated in a database associated with the scheduler module. In an embodiment of the present invention, the scheduler module operates in the release calendar mode when the scheduler module receives an input from the release calendar module to schedule the one or more workflows. The release calendar module comprises one or more planned activities associated with the testing of the ones or more applications in all stages of release testing. The release calendar module employs machine learning algorithms to analyse release patterns and propose dates for upcoming software application releases. In another embodiment of the present invention, the scheduler module operates in the ad hoc mode when the scheduler module receives an input from ad hoc module to schedule one or more ad hoc workflows. The scheduler module is further configured to employ a planned scheduling assistant that predicts, using machine learning algorithms, a next possible task which needs to be scheduled from the past experience and historic schedule data.

The system further comprises a a master controller configured to execute the one or more scheduled workflows by accessing details of the one or more scheduled workflows from an execution queue communicatively coupled to the database associated with the scheduler module. The execution of the one or more workflows by the master controller is controlled by at least one of: an emergency flag or an interrupt service routine. Further, the one or more scheduled workflows are added to the execution queue through at least one of: a queue loader function and continuous integration continuous development practice.

The system furthermore comprises an artificial intelligence based user interface module configured to facilitate the scheduling and execution of the one or more workflows, the user interface module is communicatively coupled to the scheduler module and the master controller. In embodiments of the present invention, the artificial intelligence based user interface module further configured to facilitate at least one of: download a log of the executing one or more workflows, display all application support and environment management related activities, role based access control of the system, addition of one or more workflows for execution, planning of the release activities for different stages and different environments, to develop and permanently schedule a new workflow, choose one or more modules to be executed in a sequence, and generation of one or more reports. Further, the artificial intelligence based user interface module employs a Natural Language Processing (NLP) based chatbot to assist one or more stakeholders. The artificial intelligence based user interface module further auto-populates a work module while a workflow is designed.

In another embodiment of the present invention, a method for automating environment management of one or more software applications is provided. The method comprises scheduling one or more workflows in at least one of: a release calendar mode and an ad hoc mode. In the release calendar mode, a release calendar and an associated workflow timing matrix are read to determine appropriate time to schedule one or more workflows for execution. the entries in the release calendar and the workflow timing matrix are compared to identify the execution time, date for the one or more workflows, their status and other associated details of the workflows.

The method further comprises loading an execution queue with details of the one or more scheduled workflows from the database. The one or more scheduled workflows are added to the execution queue through at least one of: a queue loader function and continuous integration continuous development practice. Finally, the one or more scheduled workflows are executed by sequentially reading each line of the execution queue.

In yet another embodiment of the present invention, a computer program product is provided. The computer program product comprises a non-transitory computer-readable medium having computer-readable program code stored thereon, the computer-readable program code comprising instructions that when executed by a processor, cause the processor to schedule one or more workflows in at least one of: a release calendar mode and an ad hoc mode, load an execution queue with details of the one or more scheduled workflows from the database, and execute the one or more scheduled workflows by sequentially reading each line of the execution queue.

### BRIEF DESCRIPTION OF THE ACCOMPANYING DRAWINGS

The present invention is described by way of embodiments illustrated in the accompanying drawings wherein:

FIG. 1 is a block diagram illustrating a system for automating environment management of one or more software applications in accordance with an embodiment of the present invention;

FIG. 2 is a flowchart illustrating a method for automating environment management of one or more software applications in accordance with an embodiment of the present invention; and

FIG. 3 illustrates an exemplary computer system in which various embodiments of the present invention may be implemented.

### DETAILED DESCRIPTION OF THE INVENTION

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

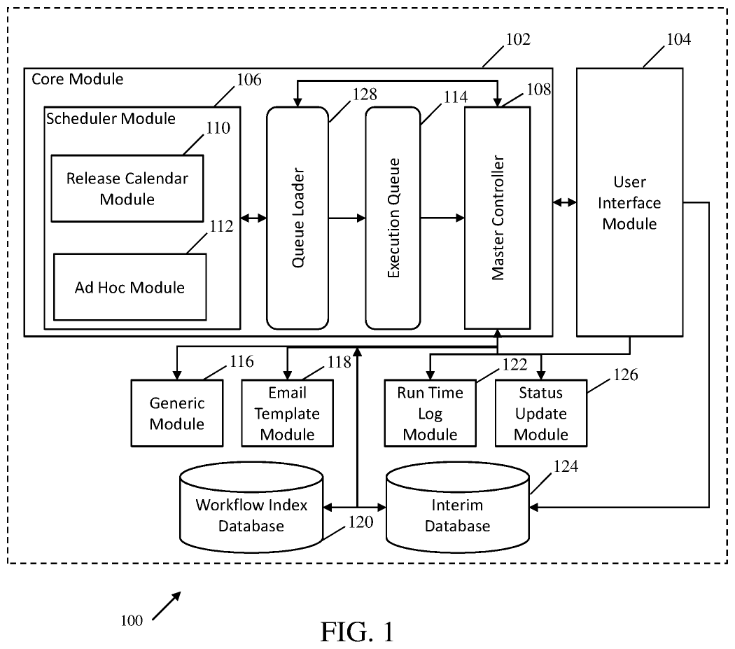

FIG. 1 is a block diagram illustrating a system 100 for automating environment management of one or more software applications in accordance with an embodiment of the present invention. The system 100 provides an end to end automation of the application environment management and the support activities for the one or more applications to facilitate release planning, testing, maintenance, and monitoring of one or more software applications. In an embodiment of the present invention, system 100 may be implemented as an on premise solution. In another embodiment of the present invention, the system 100 may be implemented in a cloud environment. Further, the one or more applications may be, without any limitation, mobile applications and web applications. To automate the environment management of the one or more software applications, the system 100 comprises a core module 102 and an associated user interface module 104. The core module 102 further comprises a scheduler module 106 and a master controller 108 communicatively coupled to each other. The scheduler module 106 further comprises a release calendar module 110 an ad hoc module 112 and is communicatively coupled to an execution queue 114. The master controller 108 is further communicatively coupled to the execution queue 114, generic module 116, an email template module 118, a workflow index database 120, a run time log module 122, an interim database 124, and a status update module 126. In an embodiment of the present invention, the core module 102 is in form of a computer program and runs on a WINDOWS virtual machine environment. Further, once the core module 102 has been installed, the core module 102 executes in the virtual machine to run the entire functionality of the system 100 from back end.

The scheduler module 106 is a bookkeeping script to schedule workflows for the master controller 108 as per inputs from a release calendar module 110 and an ad hoc module 112. In an embodiment of the present invention, the scheduler module 106 may employ a planned scheduling assistant that may predict, using machine learning algorithms, the next possible task which needs to be scheduled from the past experience and historic schedule data. Further, the scheduler module 106 is invoked when the master controller 108 finishes execution of one or more queued tasks in the execution queue 114. Next, a queue loader function 128 reads database associated with the scheduler module 106 and queues the pending tasks and invokes master controller 108 again. This may continue in loop. Further, the release calendar module 110 comprises one or more planned activities or tasks associated with the testing of the one or more applications in all stages of release testing. The one or more activities may comprise, without any limitation, capturing of a file, restoring a file, loading a database, unloading a database, environment preparation, and batch execution. In an embodiment of the present invention, the release calendar module 110 is manually populated by one or more users. In another embodiment of the present invention, the release calendar module 110 uses machine learning algorithms to understand release patterns and propose dates for upcoming software application releases.

Further in an embodiment of the present invention, the scheduler module 106 operates in a release calendar mode when the scheduler module 106 receives an input from the release calendar module 110. Further, in the release calendar mode, the scheduler module 106 may read the release calendar and an associated workflow timing matrix to determine the appropriate time to schedule the workflow. In an exemplary embodiment of the present invention, the workflow may be a comma separated value file containing the steps to be executed in sequence and may be designed and developed by one or more developers. Further, each step of a workflow may contain a step number, a generic module name, a predefined number of input arguments and a predefined number of output arguments. The workflow timing matrix comprises schedule of one or more workflows to be executed. Further, the associated workflow timing matrix stores the release calendar legend and a time frame during which the workflow would be executed. The scheduler module 106 upon reading the entries in the release calendar module 110 and the associated workflow timing matrix, may compare the entries in the release calendar module 110 and the workflow timing matrix to identify the execution time and date for the one or more workflows, ID status for the one or more workflows and other associated details of the workflows. The identified details of the one or more workflows may be stored in a database associated with the scheduler module 106 for execution of the one or more workflows by the master controller 108.

In another embodiment of the present invention, the scheduler module 106 operates in an ad hoc mode when the scheduler module 106 receives an input from the ad hoc module 112. The ad hoc module 112 facilitates execution of one or more unplanned or ad hoc tasks. The user interface module 104 facilitates inclusion of the ad hoc tasks for their execution from one or more authorized users. In an embodiment of the present invention, the ad hoc tasks may be executed for a single time or multiple recurrences. In another embodiment of the present invention, the ad hoc tasks may be executed at regular intervals for a predefined period of time. To prepare the one or more ad hoc workflows for execution, the scheduler module 106 may first identify the workflow ID, release ID, future date and time from the input provided by the one or more authorized users. The scheduler module 106 may then confirm if the ad hoc tasks have been approved by the predetermined stake-holders and whether the future date and time have been selected. In an exemplary embodiment of the present invention, the predetermined stake-holders may comprise team leaders and managers from the environment management team and the application support team. Upon a positive confirmation, the scheduler module 106 may add the one or more ad hoc tasks in the database associated with the scheduler module 106 for execution by the master controller 108.

The master controller 108 is a multithreaded program to run all the scheduled activities in parallel. In an embodiment of the present invention, the execution of the master controller 108 may be controlled by an emergency flag or an interrupt service routine. The emergency flag or the interrupt service routine may be set or reset to hold or resume execution of the workflows by the master controller 108. The user interface module 104 facilitates the one or more stakeholders to hold the execution of master controller 108 using the interrupt service routine. When the execution of the master controller 108 is held, the next step to be executed in a workflow may be stored in the interrupt stack. Thereafter, when the execution of master controller 108 is resumed, the last records from the interrupt stack are read and the execution is restarted from the step selected by the one or more stakeholders.

Further, before the master controller 108 starts the execution, the queue loader function 128 gets executed to load the execution queue 114 with the details of the workflows from the database associated with the scheduler module 106. In an embodiment of the present invention, if it may be ascertained that the scheduled time for the workflow is less than the current time, the control goes back to the master controller 108. On the other hand, when the scheduled time for the workflow is more than the current time, that workflow is ignored and no action is taken. For workflows loaded in execution queue 114, the workflow ID and release ID are read from the database associated with the scheduler module 106 and written to the execution queue 114 and the database associated with the scheduler module 106 is updated. In an embodiment of the present invention, workflows are added to the execution queue 114 through the queue loader function 128. In another embodiment of the present invention, the new workflows are added to the system and existing workflows are upgraded through Continuous Integration Continuous Development (CICD) practice of software development.

After the execution of the queue loader function 128, the master controller 108 sequentially reads each line of the execution queue 114 and determines the workflow CSV name and the corresponding release ID. Further, the master controller 108 reads the step name, module name, input arguments and output arguments. In an exemplary embodiment of the present invention, the modules are functions written in POWERSHELL and the input and output arguments are the parameters received from the POWERSHELL function. Thereafter, the master controller 108 matches the regular expression with the module name and then calls the matched module. It may be apparent to a person of ordinary skill in the art that regular expression may comprise an approximate match in case the search does not provide exact match. The master controller 108 then reads the flag file and if the flag is set, the release ID and last executed step ID are written to the interrupt file and further processing continues. The master controller 108 then first clears the execution queue 114 and thereafter reads the Getjob state. If the Getjob state is equal to complete, the Getjob and Receivejob modules are called by the master controller 108. Thereafter, the master controller 108 checks if the Getjob module has more data or not. If the Getjob module has more data, the Getjob and Receivejob modules are called again. If the Getjob has no more data, the Getjob and Receivejob modules are called and then the queue loader function 128 is invoked by the master controller 108. After the queue loader function 128 is complete it again invokes the master controller 108 and this process continues in loop.

The generic module 116 is communicatively coupled to the master controller 108 and comprises one or more modules that execute lowest level activities across different software platforms. The one or more modules may be single threaded POWERSHELL programs capable of executing one or more specific tasks. In an exemplary embodiment of the present invention, the one or more tasks may be, without any limitation, sending email, executing some script in UNIX, submitting a job in Mainframe. Further, the one or more modules of the generic module 116 may be a part of the workflows executed by the master controller 108.

The email template module 118 is communicatively coupled to the master controller 108 and may comprise one or more predefined templates of the emails that may be pushed to the one or more users through an associated Simple Mail Transfer Protocol (SMTP) server.

The workflow index database 120 is communicatively coupled to the master controller 108 and is configured to maintain a list of all the workflows that are executed by the master controller 108.

The run time log module 122 is communicatively coupled to the master controller 108 and is configured to maintain a run time log of all the workflows that are executed by the master controller 108 for future reference and audit trail. The run time log of the executed workflows may be archived at a predefined frequency. The run time log module 122 is further connected to a user panel to facilitate generation of one or more reports in connection with the workflow execution.

The interim database 124 is communicatively coupled to the master controller 108 and is configured to facilitate adding of an entry to the database associated with the scheduler module 106 through the user interface module 104 or the release calendar. The status update module 126 is also communicatively coupled to the master controller 108 and is configured to track the workflow schedule status and keep an audit trail.

The user interface module 104 is communicatively coupled to the core module 102 and provides one or more functionalities of the system 100 to the one or more users. In an embodiment of the present invention, user interface module 104 may provide a drag and drop enabled workflow designer. The user interface module 104 may provide a view of the currently executing processes that may be filtered with time range. It may also allow the one or more users to download a log of the executing processes. The user interface module 104 may also display all the application support and environment management related activities which are already complete or are expected to run in future. The one or more stake-holders for the application management or environment management may be facilitated to scope to approve the pending ad-hoc requests. The user interface module 104 may also provide a role based access control that may allow modification of the future tasks. The one or more users may also view the information about the one or more tasks.

The user interface module 104 also allows addition of one or more workflows to execute in an ad hoc mode i.e. workflow from a dropdown to run one time or at a regular interval for the current year. The associated release ID may also be added to the task through the user interface 104.

The user interface module 104 may also facilitate planning of the release activities for different stages and different environments. The user interface module 104 may employ a rule engine that may suggest future activities in one or more releases. This user interface module 104 may help one or more stakeholders like a release manager to understand the environment availability in a year.

The user interface module 104 may also facilitate a developer to develop and permanently schedule a new workflow. It may further help to choose one or more modules from the generic module 116 to be executed in a sequence. In an exemplary embodiment of the present invention, for each individual module of the one or more modules, the user interface may accept 10 input parameters and 10 output values.

The user interface module 104 may further facilitate generating reports and access management of the system. Various kinds of reports, including statistical reports, related to a test environment management system may be generated, extracted and viewed through the user interface module 104. The reports may allow the one or more stakeholders to plan one or more activities and find availabilities of the release calendar. The access management provided by the user interface module 104 may be role based. The role based access may allow addition of the one or more users to access the system. Further, the user interface module 104 may also provide a help feature to understand functionalities of one or more modules. In an embodiment of the present invention, the user interface module 104 may also employ a Natural Language Processing (NLP) based chatbot for providing help to one or more stakeholders on understanding the functionalities of one or more modules.

In an embodiment of the present invention, the user interface module 104 may provide an Artificial Intelligence (AI) enabled developer panel using which a suggested work module may be auto-populated while designing a workflow. For example, when a workflow developer may drag in a module M1 to the developer panel, it may generate a file F1 to be consumed by a module M2. The AI enabled developer panel may generate a connector line that may automatically connect M1 and M2. In an exemplary embodiment of the present invention, the automatic connection between M1 and M2 may signify that output from M1 may be provided as input to M2. The AI based developer panel may also prompt the one or more users to avoid mistakes. For example, if a date format is wrongly typed as “yyy-MM-dd” (3 ‘Y’ for year) it may be autocorrected by the workflow parameter.

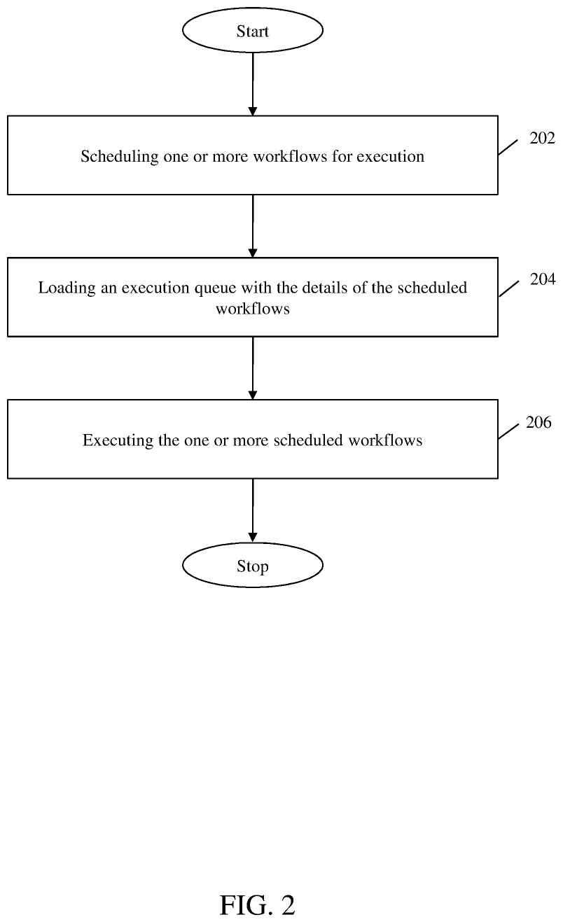

FIG. 2 is a flowchart illustrating a method for automating environment management of one or more software applications in accordance with an embodiment of the present invention. The method provides an end to end automation of the application environment management and the support activities for the one or more applications to facilitate release planning, testing, maintenance, and monitoring of one or more software applications. At step 202, one or more workflows are scheduled for execution in at least one of release calendar mode and ad hoc mode. In the release calendar mode, a release calendar and an associated workflow timing matrix are read by a scheduler to determine appropriate time to schedule one or more workflows for execution. In an exemplary embodiment of the present invention, the workflow may be a comma separated value file containing the steps to be executed in sequence and may be designed and developed by one or more developers. Further, each step of a workflow may contain a step number, a generic module name, a predefined number of input arguments and a predefined number of output arguments. The workflow timing matrix comprises schedule of one or more workflows to be executed. Further, the associated workflow timing matrix stores the release calendar legend and a time frame during which the workflow would be executed. After the entries in the release calendar and the associated workflow timing matrix are read, the entries in the release calendar module and the workflow timing matrix may be compared to identify the execution time and date for the one or more workflows, their status and other associated details of the workflows. The identified details of the one or more workflows may be stored in a database for execution of the one or more workflows.

In an ad hoc mode one or more unplanned or ad hoc tasks are scheduled. In an embodiment of the present invention, the ad hoc tasks may be scheduled for a single time execution or multiple recurrences. In another embodiment of the present invention, the ad hoc tasks may be scheduled for execution at predefine regular intervals. To schedule the one or more ad hoc workflows for execution, the workflow ID, release ID, future date and execution time are identified from the input provided by the one or more authorized users. It may then be confirmed if the ad hoc tasks have been approved by the predetermined stake-holders and whether the future date and time have been selected. In an exemplary embodiment of the present invention, the predetermined stake-holders may comprise team leaders and managers from the environment management team and the application support team. Upon a positive confirmation, the one or more ad hoc tasks may be added in the database for execution.

At step 204, an execution queue is loaded with the details of the scheduled workflows from the database. In an embodiment of the present invention, a queue loader function may be employed to load the execution queue. In an embodiment of the present invention, if it may be ascertained if the scheduled time for the workflow is less than the current time, the control goes back to the workflow execution stage. On the other hand, when the scheduled time for the workflow is more than the current time, that workflow is ignored and no action is taken. For workflows loaded in execution queue, the workflow ID and release ID are read from the database and written to the execution queue and the database containing the scheduled workflows is updated. In an embodiment of the present invention, the one or more workflows are added to the execution queue through a queue loader function. In another embodiment of the present invention, the new workflows are added to the system and existing workflows are upgraded through Continuous Integration Continuous Development (CICD) practice of software development.

At step 206, the one or more scheduled workflows are executed by sequentially reading each line of the execution queue and the workflow CSV name and the corresponding release ID. Further, the step name, module name, input arguments and output arguments are also read. In an exemplary embodiment of the present invention, the modules are functions written in POWERSHELL and the input and output arguments are the parameters received from the POWERSHELL function. Thereafter, the regular expression is matched with the module name and the matched module is called. Next, the flag file is read and if the flag is set, the release ID and last executed step ID is written to the interrupt file and further processing continues. Thereafter, the execution queue is cleared and Getjob state is read. If the Getjob state is equal to complete, the Getjob and Receivejob modules are called. Thereafter, it is checked if the Getjob module has more data or not. If the Getjob module has more data, the Getjob and Receivejob modules are again called. If the Getjob has no more data, the Getjob and Receivejob modules are called and then the queue loader program is invoked. After the queue loader function is complete it again invokes execution of the one or more workflows and this process continues in loop.

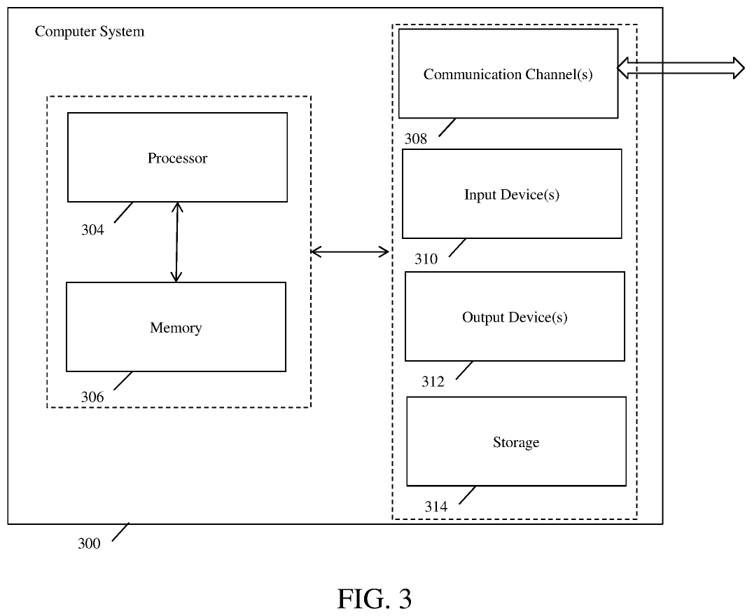

FIG. 3 illustrates an exemplary computer system in which various embodiments of the present invention may be implemented.

The computer system 302 comprises a processor 304 and a memory 306. The processor 304 executes program instructions and may be a physical processor. The processor 304 may also be a virtual processor. The computer system 302 is not intended to suggest any limitation as to scope of use or functionality of described embodiments. For example, the computer system 302 may include, but not limited to, a general-purpose computer, a programmed microprocessor, multi-core Graphics Processing Unit (GPU) to run deep learning models, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various software executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for automating environment management of one or more software applications, the system comprising:
a scheduler module configured to schedule one or more workflows in at least one of: a release calendar mode and an ad hoc mode, wherein the one or more scheduled workflows are populated in a database associated with the scheduler module;
a master controller configured to execute the one or more scheduled workflows by accessing details of the one or more scheduled workflows from an execution queue communicatively coupled to the database associated with the scheduler module; and
an artificial intelligence based user interface module configured to facilitate the scheduling and execution of the one or more workflows, the user interface module is communicatively coupled to the scheduler module and the master controller.

2. The system of claim 1, wherein the scheduler module is further configured to employ a planned scheduling assistant that predicts, using machine learning algorithms, a next possible task which needs to be scheduled from the past experience and historic schedule data.

3. The system of claim 1, wherein the scheduler module operates in the release calendar mode when the scheduler module receives an input from the release calendar module to schedule the one or more workflows.

4. The system of claim 3, wherein the release calendar module comprises one or more planned activities associated with the testing of the ones or more applications in all stages of release testing.

5. The system of claim 4, wherein the release calendar module employs machine learning algorithms to analyse release patterns and propose dates for upcoming software application releases.

6. The system of claim 1, wherein the scheduler module operates in the ad hoc mode when the scheduler module receives an input from ad hoc module to schedule one or more ad hoc workflows.

7. The system of claim 1, wherein execution of the one or more workflows by the master controller is controlled by at least one of: an emergency flag or an interrupt service routine.

8. The system of claim 1, wherein the one or more scheduled workflows are added to the execution queue through at least one of: a queue loader function and continuous integration continuous development practice.

9. The system of claim 1, wherein the artificial intelligence based user interface module further configured to facilitate at least one of: download a log of the executing one or more workflows, display all application support and environment management related activities, role based access control of the system, addition of one or more workflows for execution, planning of the release activities for different stages and different environments, to develop and permanently schedule a new workflow, choose one or more modules to be executed in a sequence, and generation of one or more reports.

10. The system of claim 1, wherein the artificial intelligence based user interface module employs a Natural Language Processing (NLP) based chatbot to assist one or more stakeholders.

11. The system of claim 1, wherein the artificial intelligence based user interface module auto-populates a work module while a workflow is designed.

12. A method for automating environment management of one or more software applications, the method comprising:
scheduling one or more workflows in at least one of:
a release calendar mode and an ad hoc mode;
loading an execution queue with details of the one or more scheduled workflows from the database; and
executing the one or more scheduled workflows by sequentially reading each line of the execution queue.

13. The method of claim 12, wherein in the release calendar mode, a release calendar and an associated workflow timing matrix are read to determine appropriate time to schedule one or more workflows for execution.

14. The method of claim 13, wherein the entries in the release calendar and the workflow timing matrix are compared to identify the execution time, date for the one or more workflows, their status and other associated details of the workflows.

15. The method of claim 12, wherein the one or more scheduled workflows are added to the execution queue through at least one of: a queue loader function and continuous integration continuous development practice.

16. A computer program product comprising:
a non-transitory computer-readable medium having computer-readable program code stored thereon, the computer-readable program code comprising instructions that when executed by a processor, cause the processor to:
schedule one or more workflows in at least one of: a release calendar mode and an ad hoc mode;
load an execution queue with details of the one or more scheduled workflows from the database; and
execute the one or more scheduled workflows by sequentially reading each line of the execution queue.
